(19) United States
(12) Patent Application Publication
(10) Pub. No.: US 2026/0348764 A1
(43) Pub. Date: Nov. 5, 2026

(54) METHOD AND APPARATUS FOR CHARACTERIZING THIN FILMS

(71) Applicant: Taiwan Semiconductor Manufacturing Company, Ltd., Hsinchu (TW)

(72) Inventors: Yen-Liang Chen, Zhubei City (TW); Lee-Feng Chen, New Taipei City (TW)

(21) Appl. No.: 19/734,450

(22) Filed: Jul. 8, 2026

Related U.S. Application Data
(62) Division of application No. 18/814,997, filed on Aug. 26, 2024.

(51) Int. Cl. G01J 9/02; G01N 21/21

(52) U.S. Cl. CPC G01J 9/02; G01N 21/21; G01J 2009/0261

(57) ABSTRACT

A method includes generating a source beam of heterodyne light toward a test layer so that the source beam is incident on the test layer at a first incidence angle. The source beam is polarized, thereby forming a reference beam. A portion of the source beam that is reflected by the test layer is polarized, thereby forming a test beam. An intensity signal of the reference beam and an intensity signal of the test beam are measured. A difference between a phase of the intensity signal of the test beam and a phase of the intensity signal of the reference beam is determined. A refractive index, an extinction coefficient, and a thickness of the test layer are determined based on the difference between the phase of the intensity signal of the test beam and the phase of the intensity signal of the reference beam.

### REFERENCE TO RELATED APPLICATION

This Application is a Divisional of U.S. application Ser. No. 18/814,997, filed on Aug. 26, 2024, the contents of which are hereby incorporated by reference in their entirety.

### BACKGROUND

Many modern tools used to characterize layers of semiconductor devices and/or layers used in semiconductor device fabrication utilize optical devices for contactless measurement. One such optical device is a reflectometer, which measures reflectance resulting from incident optical radiation interacting with a test layer. Another such optical device is an interferometer, which measures interference resulting from incident optical radiation interacting with a test layer. Another such optical device is an ellipsometer, which measures elliptical polarization resulting from incident optical radiation interacting with a test layer.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a block diagram of some embodiments of an apparatus for measuring a thickness, a refractive index, and an extinction coefficient of a sample.

FIG. 2 illustrates a diagram of some embodiments of a test intensity signal and a reference intensity signal.

FIG. 3 illustrates a block diagram of some other embodiments of the apparatus of FIG. 1.

FIG. 4 illustrates a diagram of some embodiments of a first test intensity signal, a second test intensity signal, and a reference intensity signal.

FIG. 5 illustrates a diagram of some embodiments of the distribution of the thickness, refractive index, and extinction coefficient for one layer of the sample.

FIG. 6 illustrates a block diagram of some other embodiments of the apparatus of FIG. 3.

FIG. 7, FIG. 8, and FIG. 9 illustrate block diagrams of some other embodiments of the apparatus of FIG. 6.

FIG. 10, FIG. 11, FIG. 12, and FIG. 13 illustrate cross-sectional views of some embodiments of the sample.

FIG. 14 illustrates a diagram of some embodiments of the distribution of the thickness, refractive index, and extinction coefficient for a plurality of layers of the sample.

FIG. 15, FIG. 16, and FIG. 17 illustrate block diagrams of some embodiments of a method for determining a refractive index, an extinction coefficient, and a thickness of a sample.

FIG. 18, FIG. 19, and FIG. 20 illustrate block diagrams of some other embodiments of a method for determining a refractive index, an extinction coefficient, and a thickness of a sample.

FIG. 21, FIG. 22, and FIG. 23 illustrate block diagrams of some other embodiments of a method for determining a refractive index, an extinction coefficient, and a thickness of a sample.

FIG. 24 illustrates a flow diagram of some embodiments of a method for determining a distribution of the refractive index, the extinction coefficient, and the thickness of the layer(s) of a sample across a surface of the sample.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Semiconductor device fabrication often includes the formation and/or use of thin layers (e.g., thin films). Some thin layers are disposed on or over a substrate (e.g., thin dielectric layers, thin conductive layers, thin semiconductor layers, etc.) and some other thin layers are free-standing (e.g., pellicles for photolithography). Characterizing these thin layers can be an important part of semiconductor device fabrication. For example, determining the thickness, the refractive index, the extinction coefficient, and/or other properties of these thin layers can be important for performance estimation, quality control, or the like.

In some examples, the thickness, the refractive index, and the extinction coefficient of a test layer can be determined using a spectroscopic ellipsometry process. Spectroscopic ellipsometry includes modeling (e.g., estimating) the structure of a test layer. A light source generates a linearly polarized beam of light toward a point along the test layer. The linearly polarized beam is incident on the test layer at the point along the test layer and the test layer reflects an elliptically polarized beam. The change in the polarization is measured by polarizing the reflected beam with an analyzer and measuring the intensity of the polarized reflected beam with a light sensor. The thickness, the refractive index, and the extinction coefficient of the test layer are then determined based on the measured change in polarization and the model of the test layer.

One challenge with the spectroscopic ellipsometry process is that an accurate model is needed to accurately determine the thickness, refractive index, and extinction coefficient of the test layer based on the measured change in polarization, and modeling the test layer accurately can be difficult. Thus, the likelihood of the spectroscopic ellipsometry process producing inaccurate results may be increased. Another challenge with the spectroscopic ellipsometry process is that environment factors (e.g., vibration, air disturbance, etc.) can affect the polarization of the beam between the light source and the test layer and between the test layer and the light sensor, which may affect the change in polarization measured by the light sensor. Thus, a robustness of the spectroscopic ellipsometry process may be reduced.

In various embodiments of the present disclosure, the thickness, refractive index, and extinction coefficient of the test layer are determined using a heterodyne reflectometry and common path interferometry process to improve accuracy and robustness. The process includes generating a source beam of heterodyne light with a heterodyne light source. A first portion of the source beam is polarized by a first analyzer, thereby forming a reference beam. The polarization by the first analyzer causes the source beam to interfere with itself and thus the reference beam exhibits self-interference. The self-interference of the reference beam is measured by measuring an intensity signal of the reference beam with a first light sensor. A second portion of the source beam is incident on the test layer. A portion of the incident beam is reflected by the test layer and then polarized by a second analyzer, thereby forming a test beam. The polarization by the second analyzer causes the reflected beam to interfere with itself (e.g., common-path interference) and thus the test beam exhibits self-interference. The self-interference of the test beam is measured by measuring an intensity signal of the test beam with a second light sensor. A difference between a phase of the intensity signal of the test beam and a phase of the intensity signal of the reference beam is determined. Next, the thickness, refractive index, and extinction coefficient, of the test layer are determined based on the difference between the phase of the intensity signal of the test beam and the phase of the intensity signal of the reference beam.

This heterodyne reflectometry/interferometry process does not rely on accurately modeling the test layer to accurately measure the thickness, refractive index, and extinction coefficient of the test layer. Thus, the accuracy of the measurement can be improved. Further, because this process utilizes common path heterodyne interferometry, environment factors have a reduced impact on the measured intensity of the reference beam and the test beam. Thus, the robustness of the measurement may be improved.

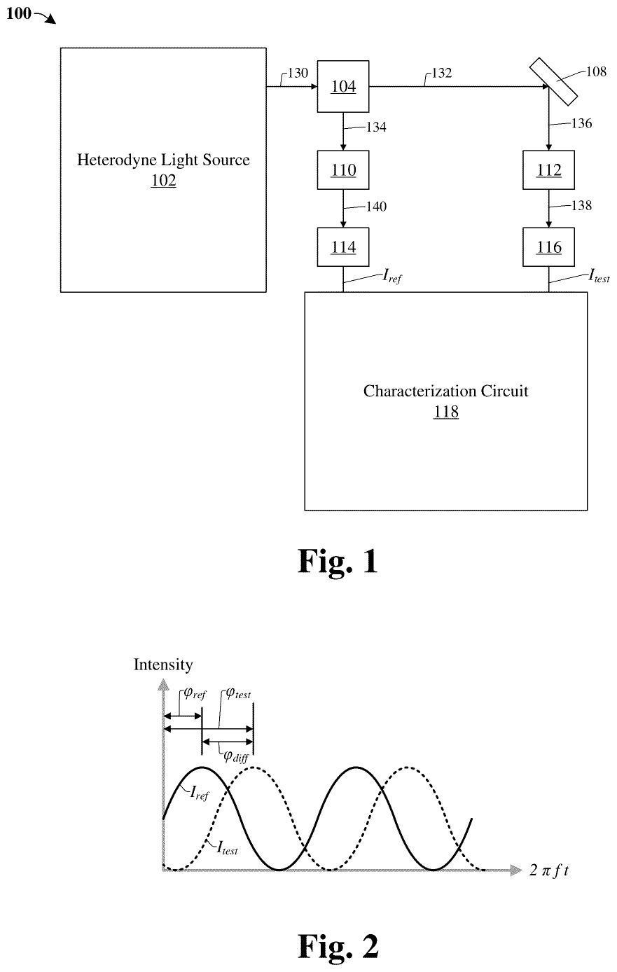

FIG. 1 illustrates a block diagram 100 of some embodiments of an apparatus for measuring a thickness, a refractive index, and an extinction coefficient of a sample 108.

The apparatus includes a heterodyne light source 102, a beam splitter 104, a first analyzer 110, a second analyzer 112, a first light sensor 114, a second light sensor 116, and a characterization circuit 118.

The beam splitter 104 is between the heterodyne light source 102 and a sample 108. The first analyzer 110 is directly between the beam splitter 104 and the first light sensor 114. The second analyzer 112 is directly between the sample 108 and the second light sensor 116. The characterization circuit 118 is coupled to the first light sensor 114 and the second light sensor 116. For example, a first input of the characterization circuit 118 is coupled to an output of the first light sensor 114 and a second input of the characterization circuit 118 is coupled to an output of the second light sensor 116.

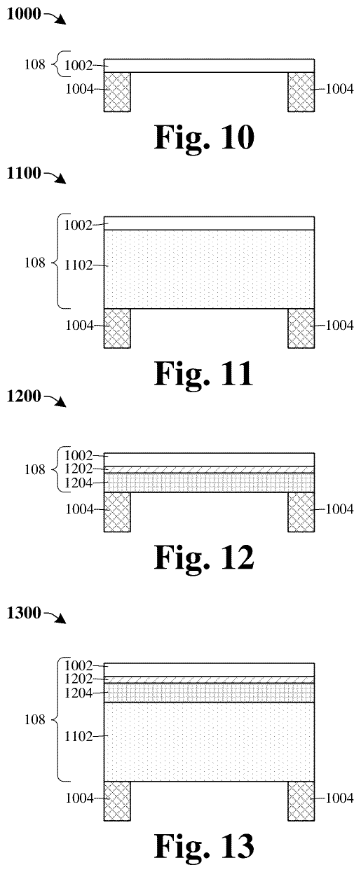

The sample 108 comprises a test layer (e.g., layer 1002 of FIGS. 10-13). In some embodiments, the test layer is free-standing (e.g., as illustrated in FIG. 10). In some other embodiments, the test layer is on a substrate (e.g., as illustrated in FIG. 11). In some embodiments, the sample 108 comprises a plurality of free-standing test layers stacked one over another (e.g., as illustrated in FIG. 12). In other some embodiments, the sample 108 comprises a plurality of test layers stacked one over another on a substrate (e.g., as illustrated in FIG. 13).

The heterodyne light source 102 generates a source beam 130 of heterodyne light toward the sample 108. The source beam 130 includes S-polarized light (e.g., light having an electric field polarized perpendicular to the plane of incidence) and P-polarized light (e.g., light having an electric field polarized parallel to the plane of incidence). A phase difference between the phase of the S-polarized light and the phase of the P-polarized light of the source beam 130 is modulated.

The beam splitter 104 reflects a first portion of the source beam 130, thereby forming a splitter-reflected beam 134. The first analyzer 110 polarizes the splitter-reflected beam 134, which causes the S-polarized light and the P-polarized light of the splitter-reflected beam 134 to interfere with each other (e.g., common-path interference), thereby forming a reference beam 140 (e.g., the beam resulting from the interference). The first light sensor 114 measures an intensity of the reference beam 140 over a period of time, which is illustrated by the reference beam intensity signal I_{ref} of FIG. 2.

The beam splitter 104 transmits a second portion of the source beam 130, thereby forming an incident beam 132. The sample 108 reflects a portion of the incident beam 132, thereby forming a sample-reflected beam 136. This interaction (e.g., reflection) with the sample 108 can affect the phase difference between the S-polarized light and the P-polarized light. For example, it can cause the phase difference between the S-polarized light and the P-polarized light of the sample-reflected beam 136 to be different than the phase difference between the S-polarized light and the P-polarized light of the incident beam 132. The second analyzer 112 polarizes the sample-reflected beam 136, which causes the S-polarized light and the P-polarized light to of the sample-reflected beam 136 interfere with each other (e.g., common-path interference), thereby forming a test beam 138 (e.g., the beam resulting from the interference). The second light sensor 116 measures an intensity of the test beam 138 over the period of time, which is illustrated by the test beam intensity signal Iₜₑₛₜ of in FIG. 2.

The characterization circuit 118 determines a phase φ_{ref} of the reference beam intensity signal I_{ref}, which indicates the phase difference between the S-polarized light and the P-polarized light of the reference beam 140. The characterization circuit 118 determines a phase φₜₑₛₜ of the test beam intensity signal Iₜₑₛₜ, which indicates the phase difference between the S-polarized light and the P-polarized light of the test beam 138.

Further, the characterization circuit 118 determines a phase difference φ_{diff} between the phase φₜₑₛₜ of the test beam intensity signal Iₜₑₛₜ and the phase φ_{ref} of the reference beam intensity signal I_{ref}. By subtracting the phase φ_{ref} of the reference beam intensity signal I_{ref} from the phase φₜₑₛₜ of the test beam intensity signal Iₜₑₛₜ, the portion of the phase difference between the S-polarized light and the P-polarized light of the test beam 138 that was caused by the interaction with the sample 108 can be determined. The effect of the sample 108 on the phase difference between the S-polarized light and the P-polarized light of the test beam 138 is used to determine several characteristics of the sample 108. For example, the characterization circuit 118 determines the refractive index, the extinction coefficient, and the thickness of the layer(s) of the sample 108 based on the phase difference φ_{diff}.

Because this heterodyne reflectometry with common-path heterodyne interferometry process does not rely on accurately modeling the sample 108 to accurately measure the thickness, refractive index, and extinction coefficient of the sample 108, the accuracy of the measurement can be improved. Further, because this process utilizes common-path heterodyne interferometry, environment factors (e.g., vibration, air disturbance, etc.) have a reduced impact on the results of the process. Thus, the robustness of the measurement may be improved.

Another challenge with the spectroscopic ellipsometry process is that because the incident beam is incident on the sample at a single point along the sample, the measurement only indicates the thickness, refractive index, and extinction coefficient at the single point along the sample 108. Thus, the thickness, refractive index, and extinction coefficient at the other points along the sample 108 are unknown and variations in the thickness, refractive index, and extinction coefficient along the sample 108 are unknown.

In some cases, the distribution of the thickness, the refractive index, and the extinction coefficient of the sample 108 across the surface of the sample 108 can be determined by scanning the spectroscopic ellipsometer across the surface of the sample 108. However, scanning may be slow and environmental variations during scanning may reduce the precision of the measurements.

In various embodiments of the present disclosure, the heterodyne reflectometry with common-path heterodyne interferometry process is performed in two dimensions to determine the distribution of the thickness, refractive index, and extinction coefficient of the sample 108 across the surface of the sample 108 at once (e.g., without having to scan across the surface of the sample 108). Thus, a speed and precision of the determination of the distribution of the thickness, refractive index, and extinction coefficient of the sample 108 can be increased.

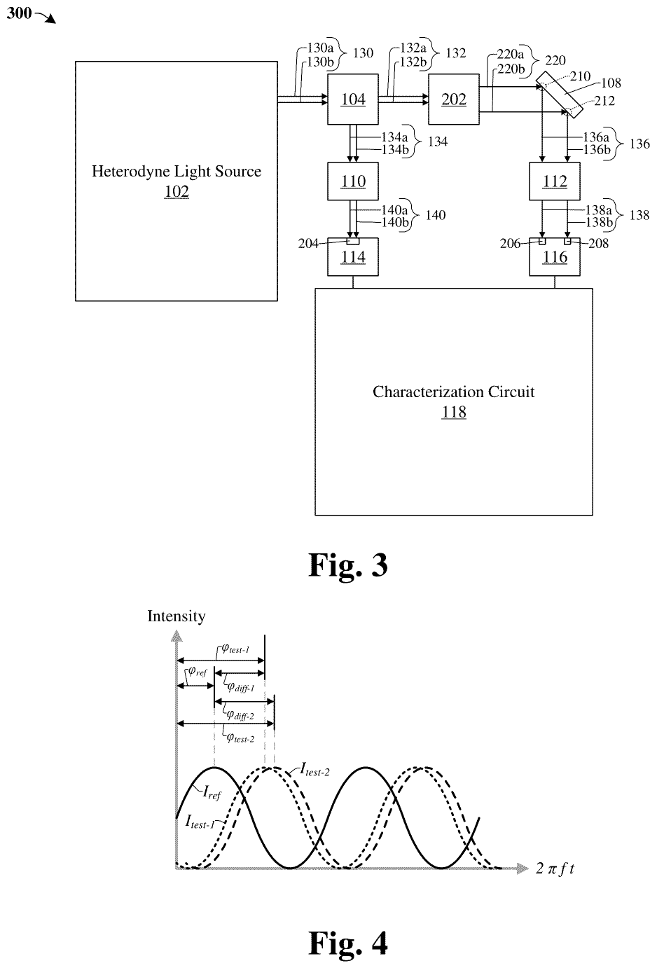

FIG. 3 illustrates a block diagram 300 of some embodiments of the apparatus of FIG. 1 in which a beam expander 202 is between the beam splitter 104 and the sample 108, and the second light sensor 116 comprises a plurality of photodetectors.

For example, the second light sensor 116 comprises a pixel array including a plurality of pixels, each pixel including a photodetector (e.g., a first pixel includes a first test photodetector 206 and a second pixel includes a second test photodetector 208). In some embodiments, the second light sensor 116 is an image sensor such as, for example, a charge-coupled device (CCD) camera, a complementary metal-oxide-semiconductor (CMOS) camera, or the like. In some embodiments, the second light sensor 116 includes a single reference photodetector 204. In some embodiments, the photodetectors are or comprise photodiodes or the like.

The source beam 130 includes a plurality of rays (e.g., a first ray 130a and a second ray 130b). A first portion of the rays of the source beam 130 are reflected by the beam splitter 104, thereby forming rays (e.g., a first ray 134a and a second ray 134b) of the splitter-reflected beam 134. The rays of the splitter-reflected beam 134 are polarized by the first analyzer 110, thereby forming rays (e.g., a first ray 140a and a second ray 140b) of the reference beam 140. The first light sensor 114 measures the intensity of the rays of the reference beam 140 over time. For example, ray 140a and ray 140b are incident on the reference photodetector 204 of the first light sensor 114 and the reference photodetector 204 measures the intensity signal of ray 140a and ray 140b, which is illustrated by the reference beam intensity signal I_{ref} in FIG. 4.

A second portion of the rays of the source beam 130 are transmitted by the beam splitter 104, thereby forming rays (e.g., a first ray 132a and a second ray 132b) of the incident beam 132. The beam expander 202 expands and collimates the rays of the incident beam 132, thereby forming an expanded incident beam 220 having the expanded and collimated rays (e.g., a first ray 220a and second ray 220b). For example, the beam expander 202 expands the distance between, and collimates, ray 132a and ray 132b, thereby forming ray 220a and ray 220b, respectively. The expanded incident beam 220 is incident on the sample 108 at a plurality of points along the sample 108 so that a surface of the sample 108 is covered by the expanded incident beam 220. For example, the first ray 220a of the expanded incident beam 220 is incident on the sample 108 at a first point 210 along the sample 108 and the second ray 220b of the expanded incident beam 220 is incident on the sample 108 at a second point 212 along the sample 108, spaced from the first point 210.

The sample 108 reflects portions of the expanded incident beam 220 at the plurality of points along the sample 108. Thus, the sample-reflected beam 136 includes a plurality of rays (e.g., a first ray 136a and a second ray 136b). For example, ray 136a emanates from first point 210 along the sample 108 as a result of the reflection of the portion of the expanded incident beam 220 at the first point 210. Similarly, ray 136b emanates from the second point 212 along the sample 108 as a result of the reflection of the portion of the expanded incident beam 220 at the second point 212.

The rays of the sample-reflected beam 136 are polarized by the second analyzer 112, thereby forming rays (e.g., a first ray 138a and a second ray 138b) of the test beam 138. The second light sensor 116 measures the intensity of the rays of the test beam 138 over time. For example, ray 138a is incident on the first test photodetector 206 of the second light sensor 116 and the first test photodetector 206 measures the intensity signal of ray 138a, which is illustrated by the first test beam intensity signal Iₜₑₛₜ₋₁ in FIG. 4. Similarly, ray 138b is incident on the second test photodetector 208 of the second light sensor 116 and the second test photodetector 208 measures the intensity signal of ray 138b, which is illustrated by the second test beam intensity signal Iₜₑₛₜ₋₂ in FIG. 4.

The characterization circuit 118 determines the phase of the test intensity signals measured by the photodetectors of the first light sensor 114. For example, the characterization circuit 118 determines a phase φₜₑₛₜ₋₁ of the test intensity signal Iₜₑₛₜ₋₁ measured by the first test photodetector 206 of the second light sensor 116 (indicating the intensity of the first ray 138a of the test beam 138) and a phase φₜₑₛₜ₋₂ of the intensity signal Iₜₑₛₜ₋₂ 1 measured by the second test photodetector 208 of the second light sensor 116 (indicating the intensity of the second ray 138b of the test beam 138).

The characterization circuit 118 determines the phase differences between the phases of the intensity signals and the phase of the reference intensity signal. For example, the characterization circuit 118 determines a phase difference φ_{diff-1} between the phase φₜₑₛₜ₋₁ of the intensity signal Iₜₑₛₜ₋₁ of the first ray 138a of the test beam 138 and the phase φ_{ref} of the intensity signal I_{ref} of the reference beam 140. Further, the characterization circuit 118 determines a phase difference φ_{diff-2} between the phase φₜₑₛₜ₋₂ of the intensity signal Iₜₑₛₜ₋₂ of the second ray 138b of the test beam 138 and the phase φ_{ref} of the intensity signal I_{ref} of the reference beam 140.

The characterization circuit 118 determines the refractive index, the extinction coefficient, and the thickness of the sample 108 at the plurality of regions along the sample 108 based on the phase differences between the phases of the intensity signals and the phase of the reference intensity signal. For example, the characterization circuit 118 determines the refractive index, the extinction coefficient, and the thickness of the layer(s) of the sample 108 at a first region along the sample 108 (within which the first point 210 is located) based on the phase difference φ_{diff-1} between the phase φₜₑₛₜ₋₁ of the intensity signal Iₜₑₛₜ₋₁ of the first ray 138a of the test beam 138 and the phase φ_{ref} of the intensity signal I_{ref} of the reference beam 140. Further, the characterization circuit 118 determines the refractive index, the extinction coefficient, and the thickness of the layer(s) of the sample 108 at the second point 212 along the sample 108 (within which the second point 212 is located) based on the second phase difference φ_{diff-2} between the phase φₜₑₛₜ₋₂ of the intensity signal Iₜₑₛₜ₋₂ of the second ray 138b of the test beam 138 and the phase φ_{ref} of the intensity signal I_{ref} of the reference beam 140.

By including the beam expander 202 between the beam splitter 104 and the sample 108, and by including the plurality of photodetectors at the second light sensor 116, the distribution of the thickness, refractive index, and extinction coefficient of the sample 108 across the surface of the sample 108 can be determined at once. Thus, a speed and precision of the determination of the distribution of the thickness, refractive index, and extinction coefficient of the sample 108 can be increased.

Although the beams of FIG. 2 are illustrated as having two rays and the second light sensor 116 of FIG. 2 is illustrated as having two photodetectors, it will be appreciated that the beams may have some other number of rays and the second light sensor 116 may have some other number of photodetectors or pixels.

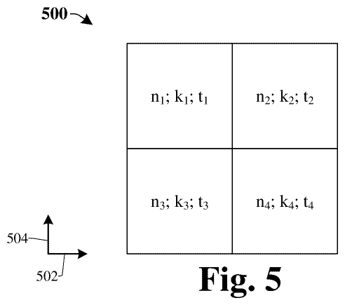

FIG. 5 illustrates a diagram 500 of some embodiments of the distribution of the thickness, refractive index, and extinction coefficient for one layer of the sample 108.

In the embodiments illustrated in FIG. 5, the second light sensor 116 has four pixels and thus four measurements are taken (corresponding to four regions along the sample 108) with the four photodetectors of the second light sensor 116. For example, the distribution includes: a first refractive index n₁, a first extinction coefficient k₁, and a first thickness t₁ corresponding to a first region along the sample 108; a second refractive index n₂, a second extinction coefficient k₂, and a second thickness t₂ corresponding to a second region along the sample 108 beside the first region in a first direction 502; a third refractive index n₃, a third extinction coefficient k₃, and a third thickness t₃ corresponding to a third region along the sample 108 beside the first region in a second direction 504 transverse to the first direction 502; and a fourth refractive index n₄, a fourth extinction coefficient k₄, and a fourth thickness t₄ corresponding to a fourth region along the sample 108 beside the second region in the second direction 504 and beside the third region in the first direction 502.

Although the simplified embodiment illustrated in FIG. 5 shows characteristics measured at four regions along the sample 108, it will be appreciated that more measurements may be taken for some greater number of regions along the sample 108 to increase the resolution of the distribution.

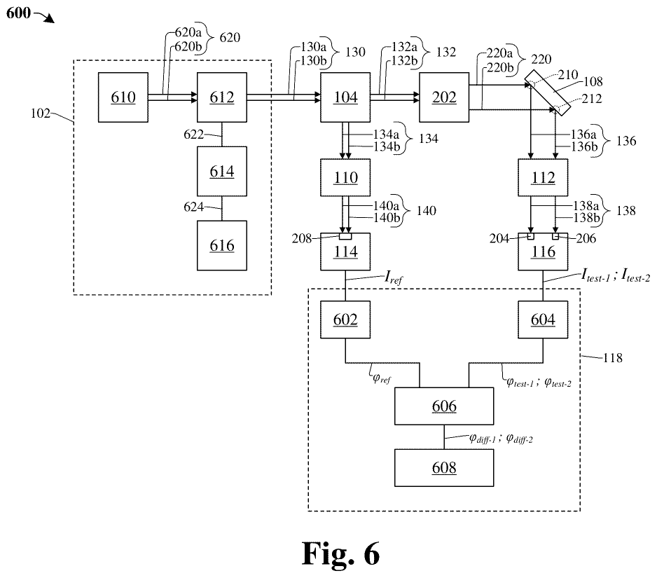

FIG. 6 illustrates a block diagram 600 of some embodiments of the apparatus of FIG. 3 in which the characterization circuit 118 comprises first phase measurement circuitry 602, second phase measurement circuitry 604, phase difference circuitry 606, and calculation circuitry 608.

The first phase measurement circuitry 602 is coupled to the first light sensor 114. For example, an input of the first phase measurement circuitry 602 is coupled to the output of the first light sensor 114. The second phase measurement circuitry 604 is coupled to the second light sensor 116. For example, an input of the second phase measurement circuitry 604 is coupled to the output of the second light sensor 116. The phase difference circuitry 606 is coupled to the first phase measurement circuitry 602 and the second phase measurement circuitry 604. For example, a first input of the phase difference circuitry 606 is coupled to an output of the first phase measurement circuitry 602 and a second input of the phase difference circuitry 606 is coupled to an output of the second phase measurement circuitry 604. The calculation circuitry 608 is coupled to the phase difference circuitry 606. For example, an input of the calculation circuitry 608 is coupled to an output of the phase difference circuitry 606.

The first phase measurement circuitry 602 receives the reference intensity signal I_{ref} from the reference photodetector 204 of the first light sensor 114 and determines the phase Φ_{ref} of the reference intensity signal I_{ref}. The second phase measurement circuitry 604 receives the test intensity signals (e.g., Iₜₑₛₜ₋₁, Iₜₑₛₜ₋₂) from the photodetectors of the second light sensor 116 and determines the phases (e.g., φₜₑₛₜ₋₁, φₜₑₛₜ₋₂) of the test intensity signals. The phase difference circuitry 606 receives the phases of the test intensity signals (e.g., φₜₑₛₜ₋₁, φₜₑₛₜ₋₂) and the phase of the reference intensity signal I_{ref} and determines the phase differences (e.g., φ_{diff-1}, φ_{diff-2}) between the phases of the test intensity signals (e.g., φₜₑₛₜ₋₁, φₜₑₛₜ₋₂) and the phase of the reference intensity signal φ_{ref}. The calculation circuitry 608 receives the phase differences (e.g., φ_{diff-1}, φ_{diff-2}) and determines the refractive index, the extinction coefficient, and the thickness of the layer(s) of the sample 108 at the plurality of regions along the sample 108 based on the phase differences.

Further, in some embodiments, the heterodyne light source 102 comprises a laser light source 610, an electro-optic (EO) modulator 612, an amplifier 614, and a function generator (FG) 616. The laser light source 610 generates a laser beam 620 including a plurality of rays (e.g., a first ray 620a and second ray 620b). The laser beam 620 includes S-polarized light and P-polarized light. The EO modulator 612 receives the laser beam 620 and a modulation signal 622, and modulates the laser beam 620 (e.g., modulates the phase difference between the S-polarized light and the P-polarized light of the laser beam 620) according to a modulation frequency of the modulation signal 622, thereby forming the source beam 130. The frame rate of the second light sensor 116 is at least twice the modulation frequency. The function generator 616 generates a base signal 624 and the amplifier 614 amplifies the base signal 624, thereby forming the modulation signal 622.

In some embodiments, the linear polarization direction of the laser beam 620 is set to a 45 degree angle to a first axis (e.g., into the page), the fast axis of the EO modulator 612 is set to be along the first axis, the fast axis of the sample 108 is set to be along the first axis, and the transmission axes of the analyzers 110, 112 are set to a 45 degree angle to the first axis.

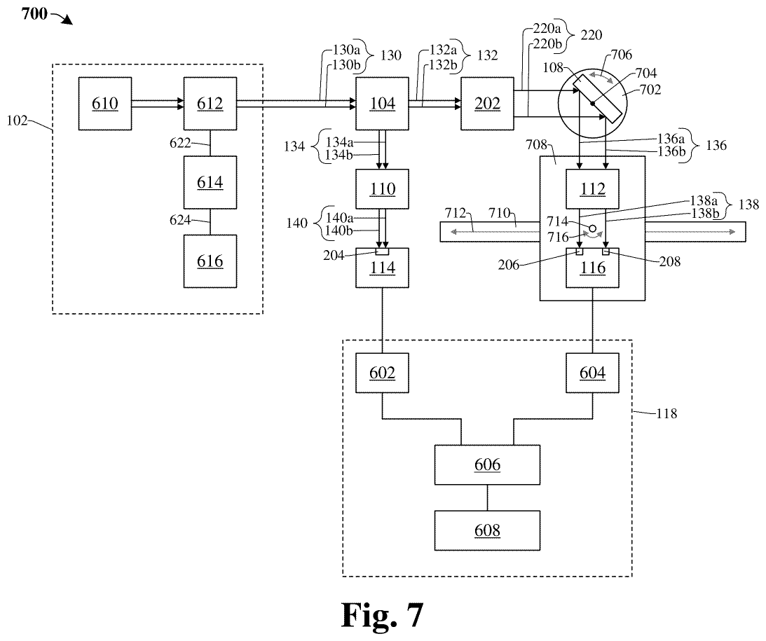

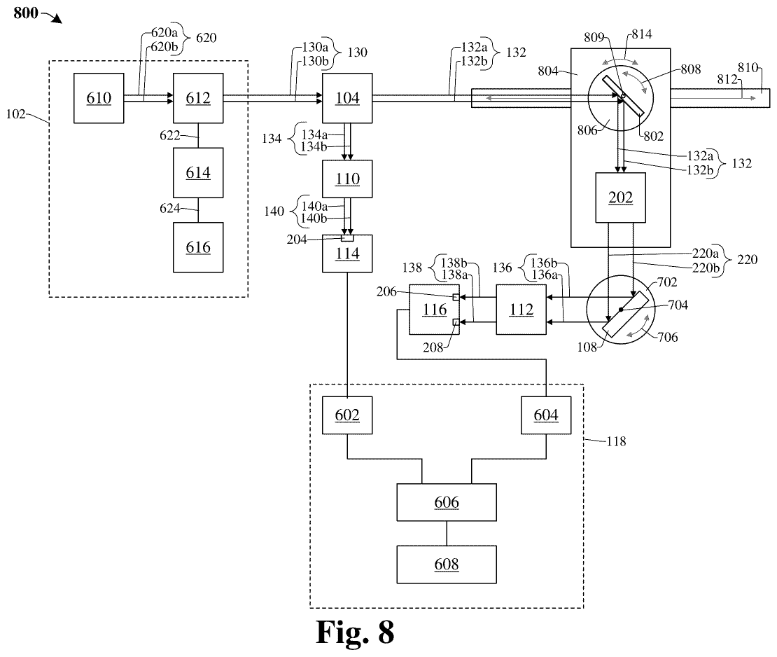

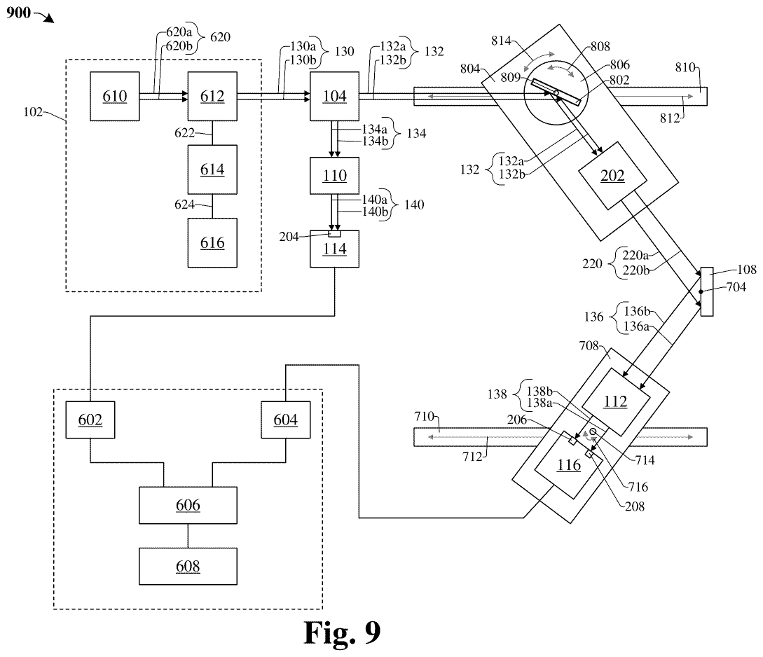

FIG. 7 illustrates a block diagram 700 of some embodiments of the apparatus of FIG. 6 further comprising a first actuator 702 and a second actuator 708.

The sample 108 is arranged on the first actuator 702. The second analyzer 112 and the second light sensor 116 are arranged on the second actuator 708.

The first actuator 702 rotates the sample 108 about an axis 704, as illustrated by arrow 706, to adjust the incidence angle of the expanded incident beam 220 on the sample 108. The second actuator 708 rotates the second analyzer 112 and the second light sensor 116 about the axis 704 to adjust the angle of the second analyzer 112 and the second light sensor 116 based on the angle of the sample 108 (e.g., based on the reflection angle of the sample-reflected beam 136) so that the sample-reflected beam 136 passes through the second analyzer 112 and the test beam 138 is incident on the second light sensor 116. In some embodiments, the second actuator 708 rotates the second analyzer 112 and the second light sensor 116 about the axis 704 by moving along a conveyor path 710, as illustrated by arrow 712, and by rotating at an axis 714, as illustrated by arrow 716. In some embodiments, axis 704 is positioned along a center of a surface of the sample 108.

FIG. 8 illustrates a block diagram 800 of some embodiments of the apparatus of FIG. 6, further comprising a mirror 802, the first actuator 702, a second actuator 804, and a third actuator 806.

The mirror 802 is between the beam splitter 104 and the beam expander 202. The beam expander 202 is between the mirror 802 and the sample 108. The sample 108 is arranged on the first actuator 702. The beam expander 202 and the third actuator 806 are arranged on the second actuator 804. The mirror 802 is arranged on the third actuator 806.

The incident beam 132 is incident on the mirror 802 and the mirror 802 reflects the incident beam 132 toward the beam expander 202. The first actuator 702 rotates the sample 108 about axis 704, as illustrated by arrow 706, the second actuator 804 rotates the beam expander 202 and the third actuator 806 (and thus the mirror 802) about axis 704, as illustrated by arrow 814, and the third actuator 806 rotates the mirror 802 about axis 809, as illustrated by arrow 808, to adjust the incidence angle of the expanded incident beam 220 on the sample 108 and to direct the sample-reflected beam 136 toward the second analyzer 112 and the second light sensor 116 so that the sample-reflected beam 136 passes through the second analyzer 112 and the test beam 138 is incident on the second light sensor 116. In some embodiments, the second actuator 804 rotates the beam expander 202 and the third actuator 806 about axis 704 by moving along a conveyor path 810, as illustrated by arrow 812, and by rotating at axis 809, as illustrated by arrow 814. In some embodiments, axis 809 is positioned along a center of a surface of the mirror 802. In some embodiments, the position of the second analyzer 112 and the second light sensor 116 is fixed.

FIG. 9 illustrates a block diagram 900 of some embodiments of the apparatus of FIG. 6, further comprising the mirror 802, actuator 804, actuator 806, and actuator 708.

The mirror 802 is between the beam splitter 104 and the beam expander 202. The beam expander 202 is between the mirror 802 and the sample 108. The beam expander 202 and actuator 806 are arranged on actuator 804. The mirror 802 is arranged on actuator 806. The second analyzer 112 and the second light sensor 116 are arranged on actuator 708.

Actuator 804 rotates the beam expander 202 and the third actuator 806 (and thus the mirror 802) about axis 704, as illustrated by arrow 814, and actuator 806 rotates the mirror 802 about axis 809, as illustrated by arrow 808, to adjust the incidence angle of the expanded incident beam 220 on the sample 108. Actuator 708 rotates the second analyzer 112 and the second light sensor 116 about the axis 704 to adjust the angle of the second analyzer 112 and the second light sensor 116 based on the incidence angle of the expanded incident beam 220 (e.g., based on the reflection angle of the sample-reflected beam 136) so that the sample-reflected beam 136 passes through the second analyzer 112 and the test beam 138 is incident on the second light sensor 116. In some embodiments, the position of the sample 108 is fixed.

FIGS. 10, 11, 12, 13 illustrate cross-sectional views 1000, 1100, 1200, 1300, respectively, of some embodiments of the sample 108.

In some embodiments, the sample 108 is on or supported by a sample holder 1004. In some embodiments (e.g., as illustrated in FIG. 10), the sample 108 is a “free-standing” single thin layer 1002. In some other embodiments (e.g., as illustrated in FIG. 11), the sample 108 includes a single thin layer 1002 and a substrate 1102 on which the single thin layer 1002 is disposed. In some other embodiments (e.g., as illustrated in FIG. 12), the sample 108 includes a plurality of “free-standing” thin layers (e.g., thin layer 1002, thin layer 1202 underlying thin layer 1002, and thin layer 1204 underlying thin layer 1202). In some other embodiments (e.g., as illustrated in FIG. 13), the sample 108 includes a plurality of thin layers (e.g., thin layers 1002, 1202, 1204) and the substrate 1102 on which the thin layers are disposed. In some embodiments, the free-standing layers may be or form a pellicle for photolithography (e.g., extreme ultraviolet (EUV) photolithography). In some embodiments, the layers on the substrate may be conductive layers, semiconductor layers, dielectric layers, or the like.

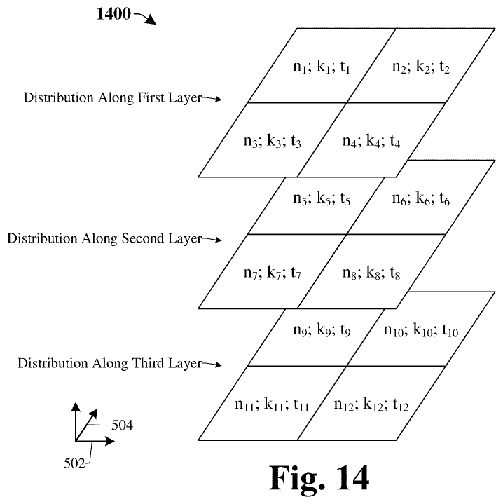

FIG. 14 illustrates a diagram 1400 of some embodiments of the distribution of the thickness, refractive index, and extinction coefficient for a plurality of layers of the sample 108.

In the embodiments illustrated in FIG. 14, the second light sensor 116 has four pixels and thus four measurements are taken (corresponding to four regions along each of the three layers of the sample 108) with the four photodetectors of the second light sensor 116. For example, the distribution of the first layer includes four refractive indexes n₁-n₄, four extinction coefficients k₁-k₄, and four thicknesses t₁-t₄. Similarly, the distribution of the second layer underlying the first layer includes four refractive indexes n₅-n₈, four extinction coefficients k₅-k₈, and four thicknesses t₅-t₈. Similarly, the distribution of the third layer underlying the second layer includes four refractive indexes n₉-n₁₂, four extinction coefficients k₉-k₁₂, and four thicknesses t₉-t₁₂.

Although the simplified embodiment illustrated in FIG. 14 shows characteristics measured at four regions along a sample having three layers, it will be appreciated that more measurements may be taken for some greater number of regions along the sample 108 to increase the resolution of the distribution, and it will be appreciated that the sample may have some other number of layers.

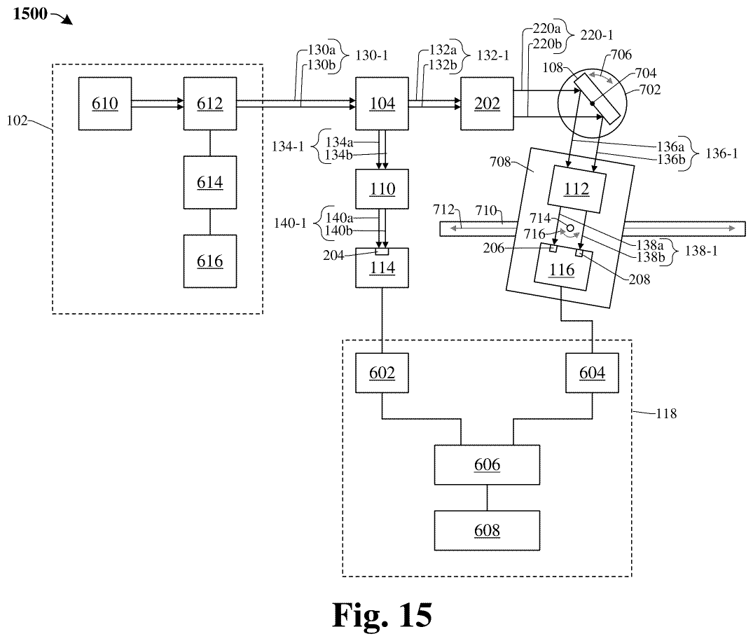

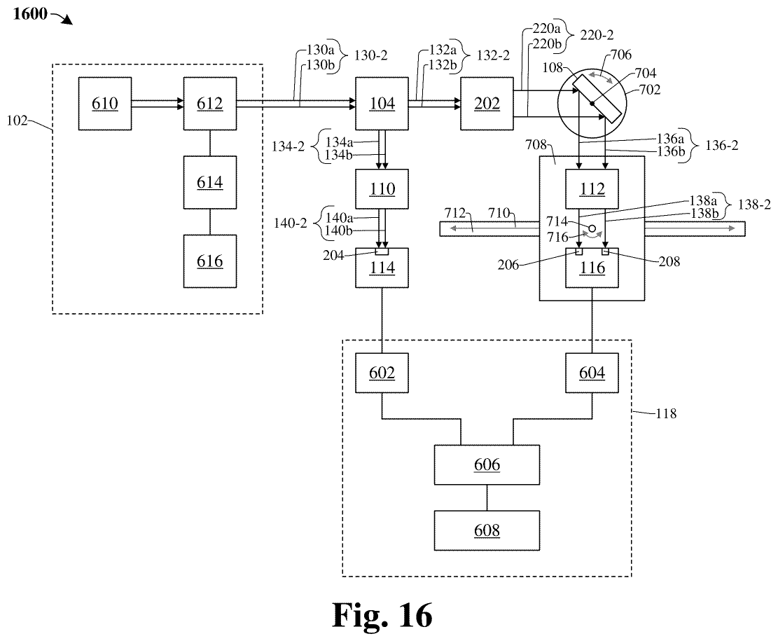

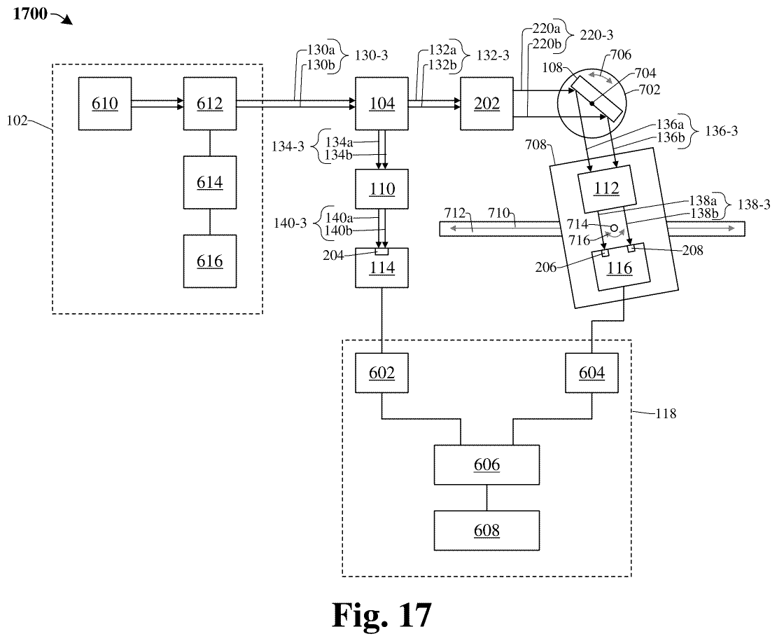

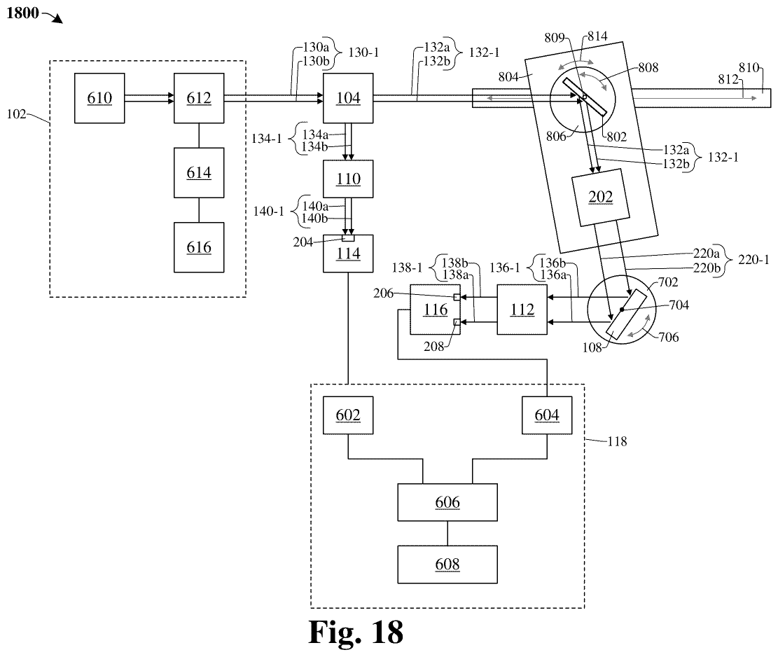

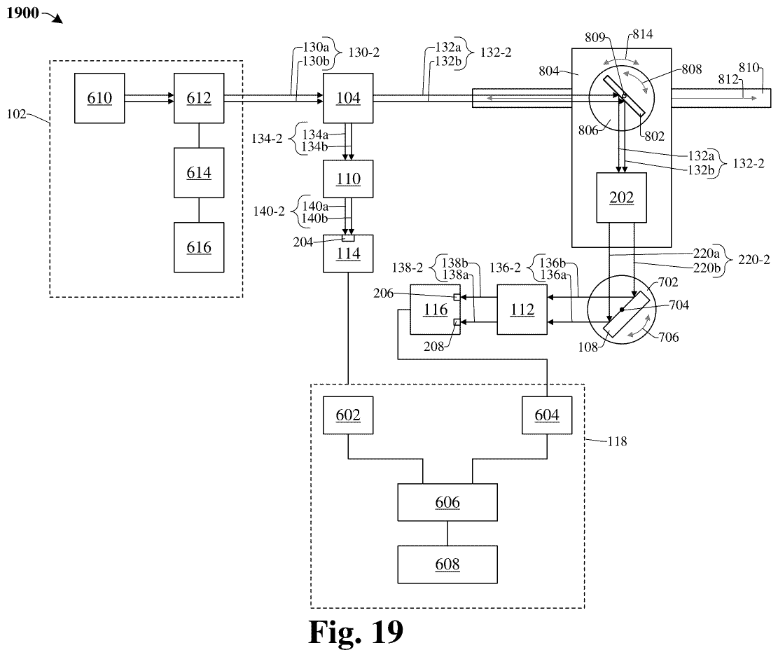

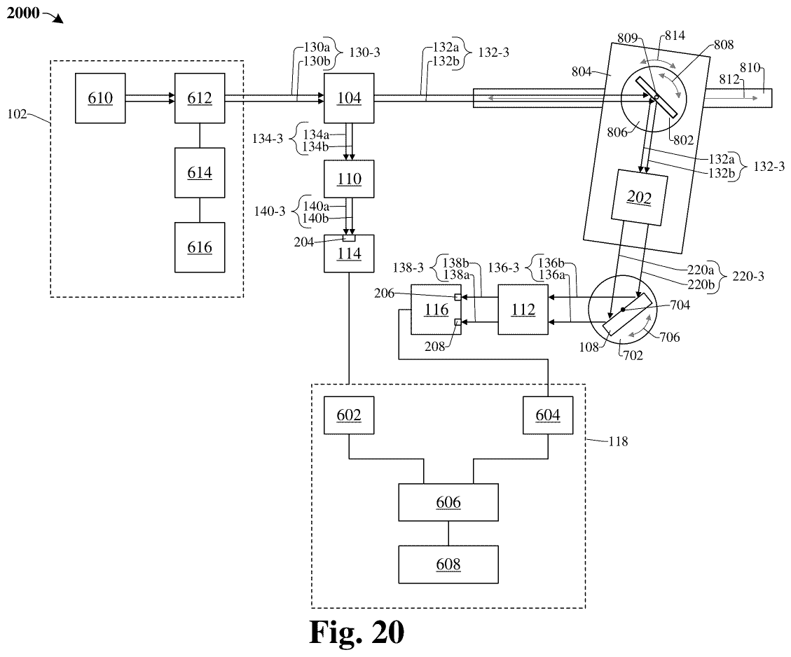

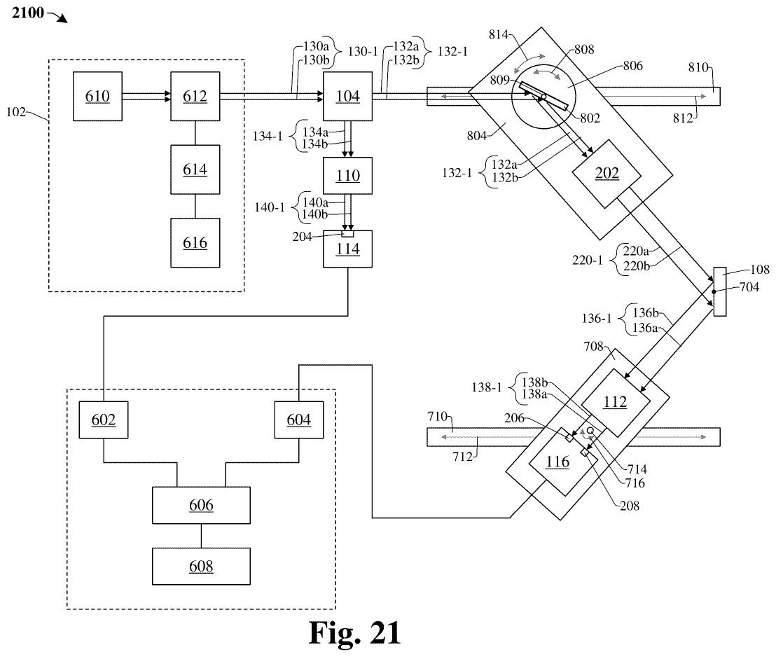

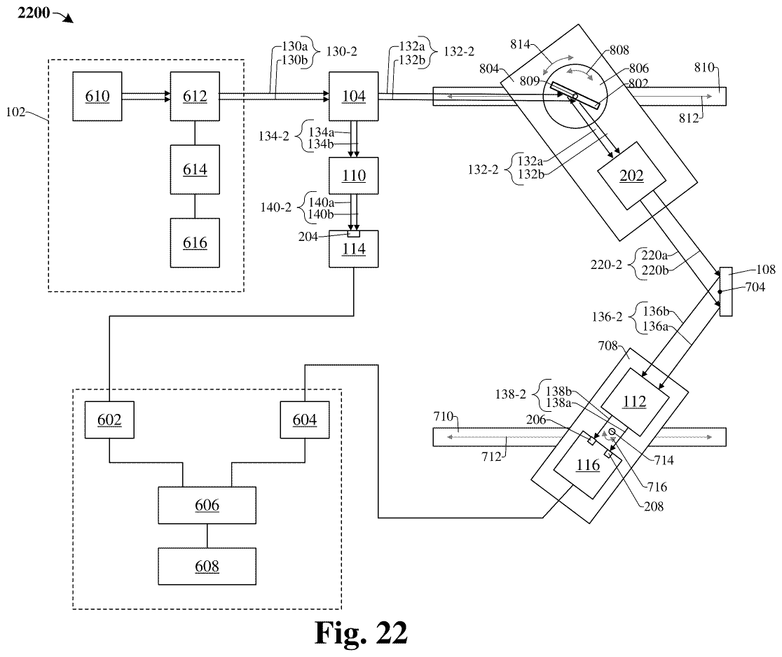

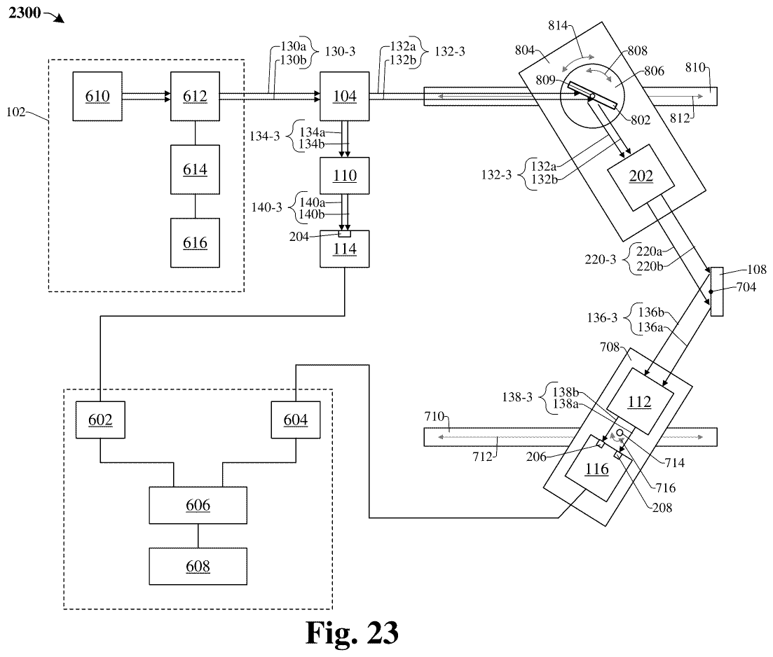

FIGS. 15, 16, 17 illustrate block diagrams 1500, 1600, 1700, respectively, of some embodiments of a method for determining a refractive index, an extinction coefficient, and a thickness of a sample 108. FIGS. 18, 19, 20 illustrate block diagrams 1800, 1900, 2000, respectively, of some other embodiments of a method for determining a refractive index, an extinction coefficient, and a thickness of a sample 108. FIGS. 21, 22, 23 illustrate block diagrams 2100, 2200, 2300, respectively, of some other embodiments of a method for determining a refractive index, an extinction coefficient, and a thickness of a sample 108. Although FIGS. 15-23 are described in relation to methods, it will be appreciated that the structures disclosed in FIGS. 15-23 are not limited to such methods, but instead may stand alone as structures independent of the methods.

First, a first measurement is taken using a first source beam 130-1 of heterodyne light at a first incidence angle. In some embodiments (e.g., as illustrated in FIGS. 15-17), the angle of incidence (e.g., the angle between the rays of the first source beam 130-1 and the line normal to the surface of the sample 108) is set to the first incidence angle by rotating, with actuator 702, the sample 108 about axis 704 to a first sample position. Analyzer 112 and light sensor 116 are rotated, by actuator 708, about axis 704 to a first sensor position based on the first sample position. In some other embodiments (e.g., as illustrated in FIGS. 18-20), the angle of incidence is set to the first incidence angle by rotating, with actuator 702, the sample 108 about axis 704 to a first sample position, by rotating, with actuator 804, a beam expander 202 and a mirror 802 about axis 704 to a first source position, and by rotating, with actuator 806, the mirror 802 about axis 809 to a first mirror position. In some other embodiments (e.g., as illustrated in FIGS. 21-23), the angle of incidence is set to the first incidence angle by rotating, with actuator 804, the beam expander 202 and the mirror 802 about axis 704 to a first source position and by rotating, with actuator 806, the mirror 802 about axis 809 to a first mirror position. Analyzer 112 and light sensor 116 are rotated, by actuator 708, about axis 704 to a first sensor position based on the first source position.

When the actuator positions have been set, a heterodyne light source 102 generates the first source beam 130-1 toward a sample 108 comprising a first test layer (e.g., layer 1002 of FIGS. 10-13). The first source beam 130-1 includes S-polarized light and P-polarized light in which a phase difference between the S-polarized light and the P-polarized light is modulated (e.g., according to a modulation frequency of a modulation signal).

A beam splitter 104 reflects a first portion of the first source beam 130-1, thereby forming a first splitter-reflected beam 134-1. A first analyzer 110 polarizes the first splitter-reflected beam 134-1, thereby forming a first reference beam 140-1. A first light sensor 114 measures an intensity signal of the first reference beam 140-1. The first phase measurement circuitry 602 determines a phase of the intensity signal of the first reference beam 140-1.

The beam splitter 104 transmits a second portion of the first source beam 130-1, thereby forming a first incident beam 132-1. A beam expander 202 expands and collimates the first incident beam 132-1, thereby forming a first expanded incident beam 220-1. In some embodiments (e.g., as illustrated in FIGS. 18-20 and 21-23), the mirror 802 reflects the first expanded incident beam 220-1 toward the beam expander 202 and the sample 108.

The first expanded incident beam 220-1 is incident on the sample 108 at the first incidence angle. A portion of the first expanded incident beam 220-1 is reflected by the sample 108, thereby forming a first sample-reflected beam 136-1.

A second analyzer 112 polarizes the first sample-reflected beam 136-1, thereby forming a first test beam 138-1. Photodetectors (e.g., pixels) of a second light sensor 116 measure the intensity of the first test beam 138-1. For example, a first test photodetector 206 measures a first intensity signal of the first test beam 138-1 (e.g., corresponding to first ray of first test beam emanating from a first region along the sample) and second pixel measures a second intensity signal of the first test beam 138-1 (e.g., corresponding to second ray of first test beam emanating from a second region along the sample). The second phase measurement circuitry 604 determines a phase of the intensity signals of the first test beam 138-1. For example, the second phase measurement circuitry 604 determines a phase of the first intensity signal of the first test beam 138-1 (measured by test photodetector 206) and a phase of the second intensity signal of the first test beam 138-1 (measured by test photodetector 208).

The phase difference circuitry 606 determines a phase difference between a phase of the intensity signal of the first test beam 138-1 and a phase of the intensity signal of the first reference beam 140-1 (e.g., a first phase difference). For example, the phase difference circuitry 606 determines a phase difference between a phase of the first intensity signal of the first test beam 138-1 (measured by test photodetector 206) and a phase of the intensity signal of the first reference beam 140-1, and determines a phase difference between a phase of the second intensity signal of the first test beam 138-1 (measured by test photodetector 208) and a phase of the intensity signal of the first reference beam 140-1

Next, a second measurement is taken using a second source beam 130-2 of heterodyne light at a second incidence angle. In some embodiments (e.g., as illustrated in FIGS. 15-17), the angle of incidence is adjusted to the second incidence angle by rotating, with actuator 702, the sample 108 about axis 704 to a second sample position. Analyzer 112 and light sensor 116 are rotated, by actuator 708, about axis 704 to a second sensor position based on the second sample position. In some other embodiments (e.g., as illustrated in FIGS. 18-20), the angle of incidence is adjusted to the second incidence angle by rotating, with actuator 702, the sample 108 about axis 704 to a second sample position, by rotating, with actuator 804, the beam expander 202 and the mirror 802 about axis 704 to a second source position, and by rotating, with actuator 806, the mirror 802 about axis 809 to a second mirror position. In some other embodiments (e.g., as illustrated in FIGS. 21-23), the angle of incidence is adjusted to the second incidence angle by rotating, with actuator 804, the beam expander 202 and the mirror 802 about axis 704 to a second source position and by rotating, with actuator 806, the mirror 802 about axis 809 to a second mirror position. Analyzer 112 and light sensor 116 are rotated, by actuator 708, about axis 704 to a second sensor position based on the second source position.

When the actuator positions have been set, the heterodyne light source 102 generates the second source beam 130-2 toward the sample 108.

The beam splitter 104 reflects a first portion of the second source beam 130-2, thereby forming a second splitter-reflected beam 134-2. The first analyzer 110 polarizes the second splitter-reflected beam 134-2, thereby forming a second reference beam 140-2. The first light sensor 114 measures an intensity signal of the second reference beam 140-2. The first phase measurement circuitry 602 determines a phase of the intensity signal of the second reference beam 140-2.

The beam splitter 104 transmits a second portion of the second source beam 130-2, thereby forming a second incident beam 132-2. The beam expander 202 expands and collimates the second incident beam 132-2, thereby forming a second expanded incident beam 220-2. In some embodiments (e.g., as illustrated in FIGS. 18-20 and 21-23), the mirror 802 reflects the second expanded incident beam 220-2 toward the beam expander 202 and the sample 108.

The second expanded incident beam 220-2 is incident on the sample 108 at the second incidence angle, which is different than the first incidence angle. A portion of the second expanded incident beam 220-2 is reflected by the sample 108, thereby forming a second sample-reflected beam 136-2.

The second analyzer 112 polarizes the second sample-reflected beam 136-2, thereby forming a second test beam 138-2. Pixels of the second light sensor 116 measure the intensity of the second test beam 138-2. The second phase measurement circuitry 604 determines phases of the intensity signals of the second test beam 138-2.

The phase difference circuitry 606 determines a phase difference between a phase of the intensity signal of the second test beam 138-2 and a phase of the intensity signal of the second reference beam 140-2 (e.g., a second phase difference).

Next, a third measurement is taken using a third source beam 130-3 of heterodyne light and a third incidence angle. In some embodiments (e.g., as illustrated in FIGS. 15-17), the angle of incidence is adjusted to the third incidence angle by rotating, with actuator 702, the sample 108 about axis 704 to a third sample position. Analyzer 112 and light sensor 116 are rotated, by actuator 708, about axis 704 to a third sensor position based on the third sample position. In some other embodiments (e.g., as illustrated in FIGS. 18-20), the angle of incidence is adjusted to the third incidence angle by rotating, with actuator 702, the sample 108 about axis 704 to a third sample position, by rotating, with actuator 804, the beam expander 202 and the mirror 802 about axis 704 to a third source position, and by rotating, with actuator 806, the mirror 802 about axis 809 to a third mirror position. In some other embodiments (e.g., as illustrated in FIGS. 21-23), the angle of incidence is adjusted to the third incidence angle by rotating, with actuator 804, the beam expander 202 and the mirror 802 about axis 704 to a third source position and by rotating, with actuator 806, the mirror 802 about axis 809 to a third mirror position. Analyzer 112 and light sensor 116 are rotated, by actuator 708, about axis 704 to a third sensor position based on the third source position.

When the actuator positions have been set, the heterodyne light source 102 generates the third source beam 130-3 toward the sample 108.

The beam splitter 104 reflects a first portion of the third source beam 130-3, thereby forming a third splitter-reflected beam 134-3. The first analyzer 110 polarizes the third splitter-reflected beam 134-3, thereby forming a third reference beam 140-3. The first light sensor 114 measures an intensity signal of the third reference beam 140-3. The first phase measurement circuitry 602 determines a phase of the intensity signal of the third reference beam 140-3.

The beam splitter 104 transmits a second portion of the third source beam 130-3, thereby forming a third incident beam 132-3. The beam expander 202 expands and collimates the third incident beam 132-3, thereby forming a third expanded incident beam 220-3. In some embodiments (e.g., as illustrated in FIGS. 18-20 and 21-23), the mirror 802 reflects the third expanded incident beam 220-3 toward the beam expander 202 and the sample 108.

The third expanded incident beam 220-2 is incident on the sample 108 at the third incidence angle, which is different than the first incidence angle and the second incidence angle. A portion of the third expanded incident beam 220-3 is reflected by the sample 108, thereby forming a third sample-reflected beam 136-3.

The second analyzer 112 polarizes the third sample-reflected beam 136-3, thereby forming a third test beam 138-3. Pixels of the second light sensor 116 measure the intensity of the third test beam 138-3. The second phase measurement circuitry 604 determines phases of the intensity signals of the third test beam 138-3.

The phase difference circuitry 606 determines a phase difference between a phase of the intensity signal of the third test beam 138-3 and a phase of the intensity signal of the third reference beam 140-3 (e.g., a third phase difference).

The calculation circuitry 608 determines a refractive index, an extinction coefficient, and a thickness of the sample 108 based on the first phase difference (corresponding to the first incidence angle), the second phase difference (corresponding to the second incidence angle), and the third phase difference (corresponding to the third incidence angle). For example, the calculation circuitry 608 determines the refractive index, the extinction coefficient, and the thickness of the layer(s) of the sample 108 at the first region along the sample based on the phase difference between the phase of the first intensity signal of the first test beam 138-1 (corresponding to test photodetector 206) and the phase of the intensity signal of the first reference beam 140-1, the phase difference between the phase of the first intensity signal of the second test beam 138-2 (corresponding to test photodetector 206) and the phase of the intensity signal of the second reference beam 140-2, and the phase difference between the phase of the first intensity signal of the third test beam 138-3 (corresponding to test photodetector 206) and the phase of the intensity signal of the third reference beam 140-3. Similarly, the calculation circuitry 608 determines the refractive index, the extinction coefficient, and the thickness of the layer(s) of the sample 108 at the second region along the sample based on the phase difference between the phase of the second intensity signal of the first test beam 138-1 (corresponding to test photodetector 208) and the phase of the intensity signal of the first reference beam 140-1, the phase difference between the phase of the second intensity signal of the second test beam 138-2 (corresponding to test photodetector 208) and the phase of the intensity signal of the second reference beam 140-2, and the phase difference between the phase of the second intensity signal of the third test beam 138-3 (corresponding to test photodetector 208) and the phase of the intensity signal of the third reference beam 140-3.

In some embodiments, to determine the distribution of the refractive index, extinction coefficient, and thickness of a sample having N layers, 3×N phase difference measurements are taken at 3×N different incidence angles. For example, to determine the distribution of the refractive index, extinction coefficient, and thickness of a sample having three layers, phase difference measurements are taken at nine different incidence angles. Further, all of the nine different phase difference measurements for the three layer sample are used to determine the refractive index, extinction coefficient, and thickness of each layer of the sample. For example, the refractive index, extinction coefficient, and thickness of the first layer of the sample are determined based on all of the nine different phase difference measurements; the refractive index, extinction coefficient, and thickness of the second layer of the sample are determined based on all of the nine different phase difference measurements; and the refractive index, extinction coefficient, and thickness of the third layer of the sample are determined based on all of the nine different phase difference measurements. In some embodiments, the incidence angle ranges between 0 degrees and 90 degrees, between 10 degrees and 80 degrees, or some other suitable range.

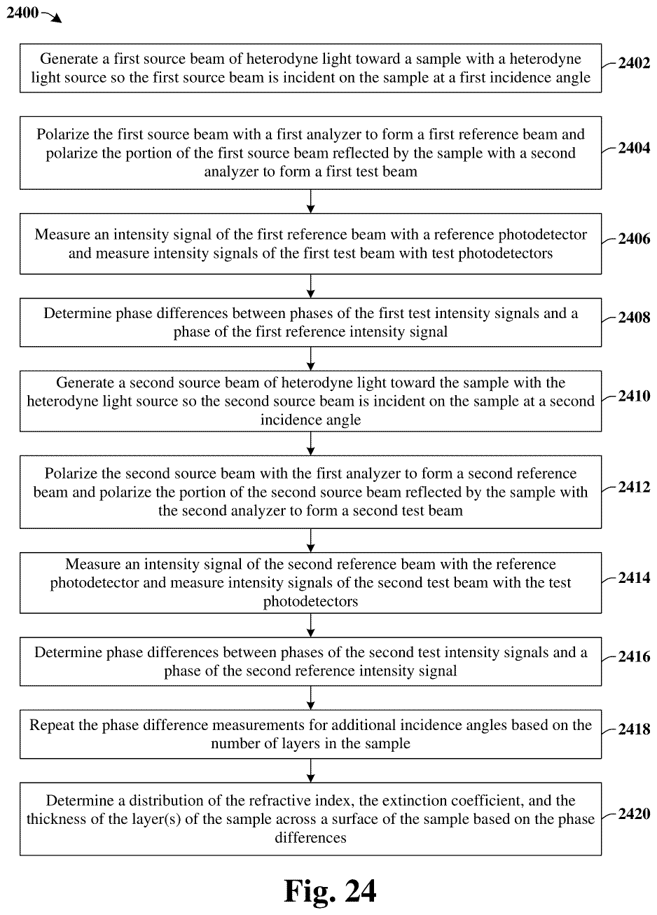

FIG. 24 illustrates a flow diagram of some embodiments of a method 2400 for determining a distribution of the refractive index, the extinction coefficient, and the thickness of the layer(s) of a sample across a surface of the sample. While method 2400 is illustrated and described below as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

At block 2402, generate a first source beam of heterodyne light toward a sample with a heterodyne light source so the first source beam is incident on the sample at a first incidence angle.

At block 2404, polarize the first source beam with a first analyzer to form a first reference beam and polarize the portion of the first source beam reflected by the sample with a second analyzer to form a first test beam.

At block 2406, measure an intensity signal of the first reference beam with a reference photodetector and measure intensity signals of the first test beam with test photodetectors.

At block 2408, determine phase differences between phases of the first test intensity signals and a phase of the first reference intensity signal. FIGS. 15, 18, 21 illustrate block diagrams 1500, 1800, 2100 of some embodiments corresponding to blocks 2402, 2404, 2406, 2408.

At block 2410, generate a second source beam of heterodyne light toward the sample with the heterodyne light source so the second source beam is incident on the sample at a second incidence angle.

At block 2412, polarize the second source beam with the first analyzer to form a second reference beam and polarize the portion of the second source beam reflected by the sample with the second analyzer to form a second test beam.

At block 2414, measure an intensity signal of the second reference beam with the reference photodetector and measure intensity signals of the second test beam with the test photodetectors.

At block 2416, determine phase differences between phases of the second test intensity signals and a phase of the second reference intensity signal. FIGS. 16, 19, 22 illustrate block diagrams 1600, 1900, 2200 of some embodiments corresponding to blocks 2410, 2412, 2414, 2416.

At block 2418, repeat the phase difference measurements for additional incidence angles based on the number of layers in the sample. FIGS. 17, 20, 23 illustrate block diagrams 1700, 2000, 2300 of some embodiments corresponding to block 2418.

At block 2420, determine a distribution of the refractive index, the extinction coefficient, and the thickness of the layer(s) of the sample across a surface of the sample based on the phase differences. FIGS. 5, 14 illustrate diagrams 500, 1400 of some embodiments of the distribution of the refractive index, the extinction coefficient, and the thickness of the layer(s) of the sample across a surface of the sample.

Accordingly, in some embodiments, the present disclosure relates to a method including generating a first source beam of heterodyne light toward a first test layer so that the first source beam is incident on the first test layer at a first incidence angle. The method includes polarizing the first source beam, thereby forming a first reference beam, and polarizing a portion of the first source beam that is reflected by the first test layer, thereby forming a first test beam. The method includes measuring an intensity signal of the first reference beam and measuring an intensity signal of the first test beam. The method includes determining a difference between a phase of the intensity signal of the first test beam and a phase of the intensity signal of the first reference beam. The method includes determining a refractive index, an extinction coefficient, and a thickness of the first test layer based on the difference between the phase of the intensity signal of the first test beam and the phase of the intensity signal of the first reference beam. In some embodiments, the method further includes generating a second source beam of heterodyne light toward the first test layer such that the second source beam is incident on the first test layer at a second incidence angle different than the first incidence angle, polarizing the second source beam, thereby forming a second reference beam, polarizing a portion of the second source beam that is reflected by the first test layer, thereby forming a second test beam, measuring an intensity signal of the second reference beam and measuring an intensity signal of the second test beam, determining a difference between a phase of the intensity signal of the second test beam and a phase of the intensity signal of the second reference beam, and determining the refractive index, the extinction coefficient, and the thickness of the first test layer further based on the difference between the phase of the intensity signal of the second test beam and the phase of the intensity signal of the second reference beam. In some embodiments, the method further includes generating a third source beam of heterodyne light toward the first test layer such that the third source beam is incident on the first test layer at a third incidence angle different than the first incidence angle and the second incidence angle, polarizing the third source beam, thereby forming a third reference beam, polarizing a portion of the third source beam that is reflected by the first test layer, thereby forming a third test beam, measuring an intensity signal of the third reference beam and measuring an intensity signal of the third test beam, determining a difference between a phase of the intensity signal of the third test beam and a phase of the intensity signal of the third reference beam, and determining the refractive index, the extinction coefficient, and the thickness of the first test layer further based on the difference between the phase of the intensity signal of the third test beam and the phase of the intensity signal of the third reference beam. In some embodiments, the method further includes setting the incidence angle of the first source beam to the first incidence angle, setting the incidence angle of the second source beam to the second incidence angle, and setting the incidence angle of the third source beam to the third incidence angle. In some embodiments, measuring the intensity signal of the first test beam includes measuring an intensity signal of a first ray of the first test beam and measuring an intensity signal of a second ray of the first test beam. In some embodiments, determining the difference between the phase of the intensity signal of the first test beam and the phase of the intensity signal of the first reference beam includes determining a difference between a phase of the intensity signal of the first ray of the first test beam and the phase of the intensity signal of the first reference beam, and determining a difference between a phase of the intensity signal of the second ray of the first test beam and the phase of the intensity signal of the first reference beam. In some embodiments, determining the refractive index, the extinction coefficient, and the thickness of the first test layer based on the difference between the phase of the intensity signal of the first test beam and the phase of the intensity signal of the first reference beam includes determining the refractive index, the extinction coefficient, and the thickness of the first test layer at a first region along the first test layer based on the difference between the phase of the intensity signal of the first ray of the first test beam and the phase of the intensity signal of the first reference beam, and determining the refractive index, the extinction coefficient, and the thickness of the first test layer at a second region along the first test layer, different than the first region, based on the difference between the phase of the intensity signal of the second ray of the first test beam and the phase of the intensity signal of the first reference beam. In some embodiments, the method further includes determining a refractive index, an extinction coefficient, and a thickness of a second test layer underlying the first test layer based on the difference between the phase of the intensity signal of the first test beam and the phase of the intensity signal of the first reference beam.

In other embodiments, the present disclosure relates to a method including generating, with a heterodyne light source, a first source beam of heterodyne light toward a sample including a first test layer. The method includes polarizing, with a first analyzer, a first portion of the first source beam, thereby forming a first reference beam. The method includes measuring, with a first light sensor, an intensity signal of the first reference beam. The method includes expanding, with a beam expander, a second portion of the first source beam, thereby forming an expanded beam. The expanded beam is incident on the first test layer at a first incidence angle and a portion of the expanded beam is reflected by the first test layer, thereby forming a first reflected beam. The method includes polarizing, with a second analyzer, the first reflected beam, thereby forming a first test beam. The method includes measuring, with a first pixel of a second light sensor, a first intensity signal of the first test beam, and measuring, with a second pixel of the second light sensor, a second intensity signal of the first test beam. The method includes determining a difference between a phase of the first intensity signal of the first test beam and a phase of the intensity signal of the first reference beam. The method includes determining a difference between a phase of the second intensity signal of the first test beam and the phase of the intensity signal of the first reference beam. The method includes determining a refractive index, an extinction coefficient, and a thickness of the first test layer at a first region along the first test layer based on the difference between the phase of the first intensity signal of the first test beam and the phase of the intensity signal of the first reference beam. The method includes determining the refractive index, the extinction coefficient, and the thickness of the first test layer at a second region along the first test layer, spaced from the first region, based on the difference between the phase of the second intensity signal of the first test beam and the phase of the intensity signal of the first reference beam. In some embodiments, the second portion of the first source beam is expanded and collimated by the beam expander such that a surface of the first test layer is covered by the expanded beam. In some embodiments, the method further includes adjusting the first incidence angle by rotating the first test layer around an axis, and rotating the second analyzer and the second light sensor around the axis in response to rotating the first test layer around the axis. In some embodiments, the method further includes reflecting, with a mirror, the second portion of the first source beam toward the beam expander and the first test layer, and adjusting the first incidence angle by rotating the first test layer, the mirror, and the beam expander around an axis. In some embodiments, the method further includes reflecting, with a mirror, the second portion of the first source beam toward the beam expander and the first test layer, adjusting the first incidence angle by rotating the mirror and the beam expander around an axis, and rotating the second analyzer and the second light sensor around the axis in response to rotating the mirror and the beam expander around the axis. In some embodiments, the method further includes reflecting, with a beam splitter, the first portion of the first source beam before polarizing the first portion of the first source beam, and transmitting, with the beam splitter, the second portion of the first source beam before expanding the second portion of the first source beam. In some embodiments, the first source beam of heterodyne light is generated by generating a precursor beam having S-polarized light and P-polarized light and modulating a phase difference between the S-polarized light and the P-polarized light of the precursor beam according to a modulation frequency.

In yet other embodiments, the present disclosure relates to an apparatus including a heterodyne light source, a beam splitter, a first analyzer, a first light sensor, a beam expander, a second analyzer, a second light sensor, and a characterization circuit. The heterodyne light source is configured to generate a first source beam of heterodyne light toward a first test layer. The beam splitter is between the heterodyne light source and the first test layer and configured to reflect a first portion of the first source beam and transmit a second portion of the first source beam. The first analyzer is configured to polarize the first portion of the first source beam, thereby forming a first reference beam. The first light sensor is configured to measure an intensity of the first reference beam. The first analyzer is between the beam splitter and the first light sensor. The beam expander is between the beam splitter and the first test layer. The beam splitter is configured to expand and collimate the second portion of the first source beam, thereby forming an expanded beam. The second analyzer is configured to polarize a portion of the expanded beam that is reflected by the first test layer, thereby forming a first test beam. The second light sensor includes a first pixel and a second pixel configured to measure an intensity of the first test beam. The second analyzer is between the first test layer and the second light sensor. The characterization circuit is coupled to the first light sensor and the second light sensor. The characterization circuit is configured to determine a difference between a phase of the intensity of the first test beam and a phase of the intensity of the first reference beam. The characterization circuit is configured to determine a refractive index, an extinction coefficient, and a thickness of the first test layer based on the difference between the phase of the intensity of the first test beam and the phase of the intensity of the first reference beam. In some embodiments, the apparatus further includes a first actuator configured to rotate the first test layer around an axis to adjust an incidence angle at which the expanded beam is incident on the first test layer, and a second actuator configured to rotate the second analyzer and the second light sensor around the axis. In some embodiments, the apparatus further includes a mirror between the beam splitter and the beam expander and configured to reflect the second portion of the first source beam toward the beam expander and the first test layer, a first actuator configured to rotate the first test layer around an axis, and a second actuator configured to rotate the mirror and the beam expander around the axis to adjust an incidence angle at which the expanded beam is incident on the first test layer. In some embodiments, the apparatus further includes a mirror between the beam splitter and the beam expander and configured to reflect the second portion of the first source beam toward the beam expander and the first test layer, a first actuator configured to rotate the mirror and the beam expander around an axis to adjust an incidence angle at which the expanded beam is incident on the first test layer, and a second actuator configured to rotate the second analyzer and the second light sensor around the axis. In some embodiments, the heterodyne light source includes a laser light source configured to generate a laser beam including S-polarized light and P-polarized light, and the heterodyne light source further includes a modulator configured to modulate a phase difference between the S-polarized light and the P-polarized light of the laser beam.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
generating a first source beam of heterodyne light toward a first test layer such that the first source beam is incident on the first test layer at a first incidence angle;
polarizing the first source beam, thereby forming a first reference beam, and polarizing a portion of the first source beam that is reflected by the first test layer, thereby forming a first test beam;
measuring an intensity signal of the first reference beam and measuring an intensity signal of the first test beam;
determining a difference between a phase of the intensity signal of the first test beam and a phase of the intensity signal of the first reference beam; and
determining a refractive index, an extinction coefficient, and a thickness of the first test layer based on the difference between the phase of the intensity signal of the first test beam and the phase of the intensity signal of the first reference beam.

2. The method of claim 1, further comprising:
generating a second source beam of heterodyne light toward the first test layer such that the second source beam is incident on the first test layer at a second incidence angle different than the first incidence angle;
polarizing the second source beam, thereby forming a second reference beam, and polarizing a portion of the second source beam that is reflected by the first test layer, thereby forming a second test beam;
measuring an intensity signal of the second reference beam and measuring an intensity signal of the second test beam;
determining a difference between a phase of the intensity signal of the second test beam and a phase of the intensity signal of the second reference beam; and
determining the refractive index, the extinction coefficient, and the thickness of the first test layer further based on the difference between the phase of the intensity signal of the second test beam and the phase of the intensity signal of the second reference beam.

3. The method of claim 2, further comprising:
generating a third source beam of heterodyne light toward the first test layer such that the third source beam is incident on the first test layer at a third incidence angle different than the first incidence angle and the second incidence angle;
polarizing the third source beam, thereby forming a third reference beam, and polarizing a portion of the third source beam that is reflected by the first test layer, thereby forming a third test beam;
measuring an intensity signal of the third reference beam and measuring an intensity signal of the third test beam;
determining a difference between a phase of the intensity signal of the third test beam and a phase of the intensity signal of the third reference beam; and
determining the refractive index, the extinction coefficient, and the thickness of the first test layer further based on the difference between the phase of the intensity signal of the third test beam and the phase of the intensity signal of the third reference beam.

4. The method of claim 3, further comprising:
setting the incidence angle of the first source beam to the first incidence angle;
setting the incidence angle of the second source beam to the second incidence angle; and
setting the incidence angle of the third source beam to the third incidence angle.

5. The method of claim 1, wherein measuring the intensity signal of the first test beam comprises measuring an intensity signal of a first ray of the first test beam and measuring an intensity signal of a second ray of the first test beam.

6. The method of claim 5, wherein determining the difference between the phase of the intensity signal of the first test beam and the phase of the intensity signal of the first reference beam comprises:
determining a difference between a phase of the intensity signal of the first ray of the first test beam and the phase of the intensity signal of the first reference beam, and
determining a difference between a phase of the intensity signal of the second ray of the first test beam and the phase of the intensity signal of the first reference beam.

7. The method of claim 6, wherein determining the refractive index, the extinction coefficient, and the thickness of the first test layer based on the difference between the phase of the intensity signal of the first test beam and the phase of the intensity signal of the first reference beam comprises:
determining the refractive index, the extinction coefficient, and the thickness of the first test layer at a first region along the first test layer based on the difference between the phase of the intensity signal of the first ray of the first test beam and the phase of the intensity signal of the first reference beam, and
determining the refractive index, the extinction coefficient, and the thickness of the first test layer at a second region along the first test layer, different than the first region, based on the difference between the phase of the intensity signal of the second ray of the first test beam and the phase of the intensity signal of the first reference beam.

8. The method of claim 1, further comprising:
determining a refractive index, an extinction coefficient, and a thickness of a second test layer underlying the first test layer based on the difference between the phase of the intensity signal of the first test beam and the phase of the intensity signal of the first reference beam.

9. A method comprising:
generating, with a heterodyne light source, a first source beam of heterodyne light toward a sample comprising a first test layer;
polarizing, with a first analyzer, a first portion of the first source beam, thereby forming a first reference beam;
measuring, with a first light sensor, an intensity signal of the first reference beam;
expanding, with a beam expander, a second portion of the first source beam, thereby forming an expanded beam, wherein the expanded beam is incident on the first test layer at a first incidence angle and a portion of the expanded beam is reflected by the first test layer, thereby forming a first reflected beam;
polarizing, with a second analyzer, the first reflected beam, thereby forming a first test beam;
measuring, with a first pixel of a second light sensor, a first intensity signal of the first test beam, and measuring, with a second pixel of the second light sensor, a second intensity signal of the first test beam;
determining a difference between a phase of the first intensity signal of the first test beam and a phase of the intensity signal of the first reference beam, and determining a difference between a phase of the second intensity signal of the first test beam and the phase of the intensity signal of the first reference beam; and
determining a refractive index, an extinction coefficient, and a thickness of the first test layer at a first region along the first test layer based on the difference between the phase of the first intensity signal of the first test beam and the phase of the intensity signal of the first reference beam, and determining the refractive index, the extinction coefficient, and the thickness of the first test layer at a second region along the first test layer, spaced from the first region, based on the difference between the phase of the second intensity signal of the first test beam and the phase of the intensity signal of the first reference beam.

10. The method of claim 9, wherein the second portion of the first source beam is expanded and collimated by the beam expander such that a surface of the first test layer is covered by the expanded beam.

11. The method of claim 9, further comprising:
adjusting the first incidence angle by rotating the first test layer around an axis; and
rotating the second analyzer and the second light sensor around the axis in response to rotating the first test layer around the axis.

12. The method of claim 9, further comprising:
reflecting, with a mirror, the second portion of the first source beam toward the beam expander and the first test layer; and
adjusting the first incidence angle by rotating the first test layer, the mirror, and the beam expander around an axis.

13. The method of claim 9, further comprising:
reflecting, with a mirror, the second portion of the first source beam toward the beam expander and the first test layer;
adjusting the first incidence angle by rotating the mirror and the beam expander around an axis; and
rotating the second analyzer and the second light sensor around the axis in response to rotating the mirror and the beam expander around the axis.

14. The method of claim 9, further comprising:
reflecting, with a beam splitter, the first portion of the first source beam before polarizing the first portion of the first source beam; and
transmitting, with the beam splitter, the second portion of the first source beam before expanding the second portion of the first source beam.

15. The method of claim 9, wherein the first source beam of heterodyne light is generated by generating a precursor beam having S-polarized light and P-polarized light and modulating a phase difference between the S-polarized light and the P-polarized light of the precursor beam according to a modulation frequency.

16. An apparatus comprising:
a heterodyne light source configured to generate a first source beam of heterodyne light toward a first test layer;
a beam splitter between the heterodyne light source and the first test layer and configured to reflect a first portion of the first source beam and transmit a second portion of the first source beam;
a first analyzer configured to polarize the first portion of the first source beam, thereby forming a first reference beam;
a first light sensor configured to measure an intensity of the first reference beam, wherein the first analyzer is between the beam splitter and the first light sensor;
a beam expander between the beam splitter and the first test layer and configured to expand and collimate the second portion of the first source beam, thereby forming an expanded beam;
a second analyzer configured to polarize a portion of the expanded beam that is reflected by the first test layer, thereby forming a first test beam;
a second light sensor comprising a first pixel and a second pixel configured to measure an intensity of the first test beam, wherein the second analyzer is between the first test layer and the second light sensor; and
a characterization circuit coupled to the first light sensor and the second light sensor and configured to determine a difference between a phase of the intensity of the first test beam and a phase of the intensity of the first reference beam, and determine a refractive index, an extinction coefficient, and a thickness of the first test layer based on the difference between the phase of the intensity of the first test beam and the phase of the intensity of the first reference beam.

17. The apparatus of claim 16, further comprising:
a first actuator configured to rotate the first test layer around an axis to adjust an incidence angle at which the expanded beam is incident on the first test layer; and
a second actuator configured to rotate the second analyzer and the second light sensor around the axis.

18. The apparatus of claim 16, further comprising:
a mirror between the beam splitter and the beam expander and configured to reflect the second portion of the first source beam toward the beam expander and the first test layer;
a first actuator configured to rotate the first test layer around an axis; and
a second actuator configured to rotate the mirror and the beam expander around the axis to adjust an incidence angle at which the expanded beam is incident on the first test layer.

19. The apparatus of claim 16, further comprising:
a mirror between the beam splitter and the beam expander and configured to reflect the second portion of the first source beam toward the beam expander and the first test layer;
a first actuator configured to rotate the mirror and the beam expander around an axis to adjust an incidence angle at which the expanded beam is incident on the first test layer; and
a second actuator configured to rotate the second analyzer and the second light sensor around the axis.

20. The apparatus of claim 16, wherein the heterodyne light source comprises a laser light source configured to generate a laser beam including S-polarized light and P-polarized light, and wherein the heterodyne light source further comprises a modulator configured to modulate a phase difference between the S-polarized light and the P-polarized light of the laser beam.
